(19) United States
(12) Patent Application Publication
(10) Pub. No.: US 2026/0349808 A1
(43) Pub. Date: Nov. 5, 2026

(54) MANAGING COMPUTATIONAL RESOURCES USING ENGAGEMENT ANALYTICS

(71) Applicant: S&P Global Inc., New York, NY (US)

(72) Inventors: Manikandarajan Shanmugavel, Glen Allen, VA (US); Onik Kurktchian, Wimbledon (GB)

(21) Appl. No.: 19/195,800

(22) Filed: May 1, 2025

(51) Int. Cl. G06F 9/50

(52) U.S. Cl. CPC G06F 9/5027

(57) ABSTRACT

An illustrative embodiment provides a computer-implemented method for managing a trial environment. The method comprises using a processor set to initiate the trial environment for a user to simulate a product before subscription to the product. In this example, a number of computational resources are allocated to the trial environment. The processor set monitors the trial environment to identify user activities in the trial environment for the user over a period of time. The processor set determines an engagement score for the user based on the user activities in the trial environment for the user over the period of time. The processor set adjusts the number of computational resources allocated to the trial environment based on the engagement score.

### BACKGROUND INFORMATION

### 1. Field

The present disclosure relates generally to managing computational resources using engagement analytics for a trial platform.

### 2. Background

A trial environment is a temporary or limited-access system, service, or software environment designed to allow users to explore, evaluate, or test features of products before committing to full use or purchase. The trial environment serves as a way for individuals or organizations to experience the capabilities and benefits of products without incurring immediate costs or obligations.

In this case, a trial environment usually offers access to core functionalities for a fixed period or with certain usage limitations, such as restricted features, limited storage, or capped usage. Such configurations allow users to understand how the trial environment fits their needs and how well the trial platform environment is in specific contexts.

### SUMMARY

An illustrative embodiment provides a computer-implemented method for managing a trial environment. The method comprises using a processor set to initiate the trial environment for a user to simulate a product before subscription to the product. In this example, a number of computational resources are allocated to the trial environment. The processor set monitors the trial environment to identify user activities in the trial environment for the user over a period of time. The processor set determines an engagement score for the user based on the user activities in the trial environment for the user over the period of time. The processor set adjusts the number of computational resources allocated to the trial environment based on the engagement score.

Another illustrative embodiment provides a computer system for managing a trial environment. The system comprises a processor set, a set of one or more computer-readable storage media, and program instructions stored on the set of one or more storage media to cause the processor set to perform operations comprising initiating the trial environment for a user to simulate a product before subscription to the product, wherein a number of computational resources are allocated to the trial environment; monitoring the trial environment to identify user activities in the trial environment for the user over a period of time; determining an engagement score for the user based on the user activities in the trial environment for the user over the period of time; and adjusting the number of computational resources allocated to the trial environment based on the engagement score.

Another illustrative embodiment provides a computer program product for managing a trial environment. The computer program product comprises a set of one or more computer-readable storage media, and program instructions stored in the set of one or more storage media to perform operations comprising using a processor set to initiate the trial environment for a user to simulate a product before subscription to the product, where a number of computational resources are allocated to the trial environment; to monitor the trial environment to identify user activities in the trial environment for the user over a period of time; to determine an engagement score for the user based on the user activities in the trial environment for the user over the period of time; and to adjust the number of computational resources allocated to the trial environment based on the engagement score.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a trial management environment in accordance with an illustrative embodiment;

FIG. 3 depicts a process flow for generating engagement scores for users in accordance with an illustrative embodiment;

FIG. 4 depicts adjustment of budget policies and computational resources in accordance with an illustrative embodiment;

FIG. 5 depicts a flowchart illustrating a process for adjusting computational resources to a trial environment in accordance with an illustrative embodiment;

FIG. 6 depicts a flowchart illustrating a process for allocating computational resources to a trial environment in accordance with an illustrative embodiment;

FIG. 7 depicts a flowchart illustrating a process for modifying access to the trial environment for the user in accordance with an illustrative embodiment; and

FIG. 8 is a block diagram of a data processing system in accordance with an illustrative embodiment.

### DETAILED DESCRIPTION

The illustrative embodiments recognize and take into account a number of considerations. For example, the illustrative embodiments recognize and take into account that traditional trial platforms allocate fixed amounts of computational resources regardless of actual usage of the trial platforms.

The illustrative embodiments recognize and take into account that it is beneficial to correlate specific usage patterns with conversion likelihood and create a machine learning model that helps prioritize sales resources toward high-potential prospects while reducing investment in low-engagement trials.

The illustrative embodiments also recognize and take into account that existing solutions of trial environments provide identical trial experiences to all customers regardless of their engagement level, which leads to missing opportunities to enhance experiences for serious evaluators.

In addition, the illustrative embodiments recognize and take into account that existing solutions of trial environments react to computational demand rather than proactively adjusting resources based on engagement quality and conversion potential. Further, existing solutions of trial environments require human intervention to modify resource allocations during trials, which can create operational inefficiencies.

Thus, illustrative embodiments of the present invention provide a computer implemented method, computer system, and computer program product for managing a trial environment. The method comprises using a processor set to initiate the trial environment for a user to simulate a product before subscription to the product. In this example, a number of computational resources are allocated to the trial environment. The processor set monitors the trial environment to identify user activities in the trial environment for the user over a period of time. The processor set determines an engagement score for the user based on the user activities in the trial environment for the user over the period of time. The processor set adjusts the number of computational resources allocated to the trial environment based on the engagement score.

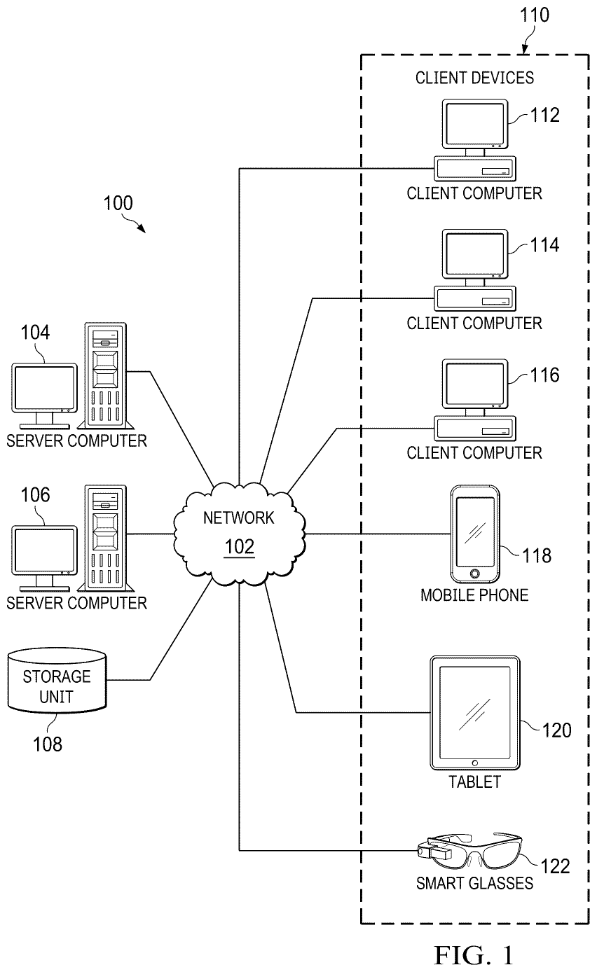

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

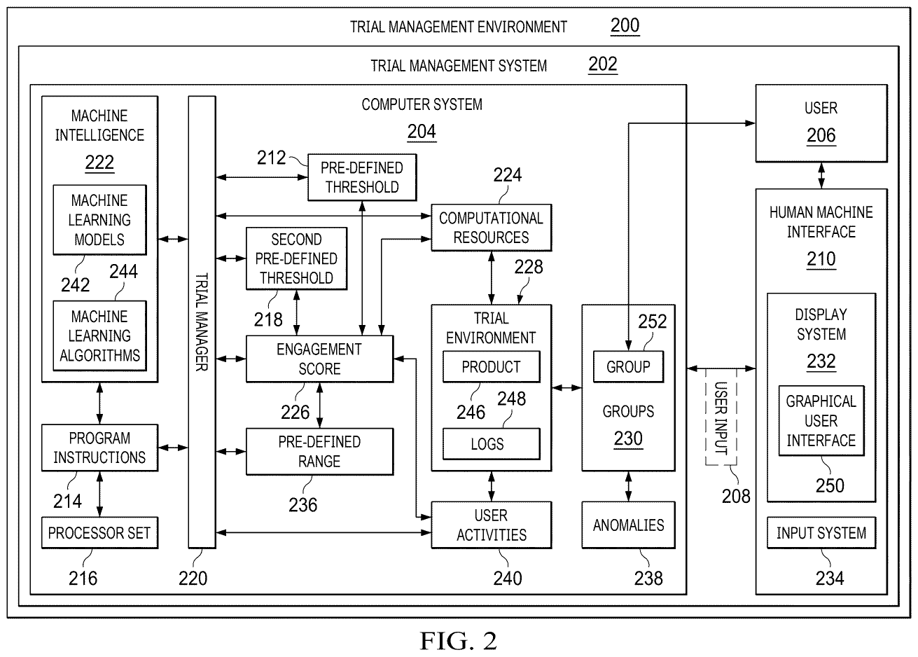

With reference now to FIG. 2, an illustration of a block diagram of a trial management environment is depicted in accordance with an illustrative embodiment. In this illustrative example, trial management environment 200 includes components that can be implemented in hardware such as the hardware shown in network data processing system 100 in FIG. 1.

In this illustrative example, trial management system 202 in trial management environment 200 enables management of trial environment 228 for user 206. As depicted, trial environment 228 is a temporary or limited-access system, service, or software environment designed to allow users to explore, evaluate, or test features of products before committing to full use or purchase.

In this example, trial environments such as trial environment 228 can be dynamically created and terminated based on request. For example, a termination notice can be sent to user 206 a period of time before trial expiration and ask if extension is requested. Subsequently, trial environment 228 can be destroyed or maintained according to the response from user 206.

In this illustrative example, trial management system 202 includes computer system 204 which includes trial manager 220. Trial manager 220 is located in computer system 204.

Trial manager 220 can be implemented in software, hardware, firmware, or a combination thereof. When software is used, the operations performed by trial manager 220 can be implemented in program instructions configured to run on hardware, such as a processor unit. When firmware is used, the operations performed by trial manager 220 can be implemented in program instructions and data and stored in persistent memory to run on a processor unit. When hardware is employed, the hardware can include circuits that operate to perform the operations in trial manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, trial manager 220 initiates trial environment 228 for user 206 to simulate product 246 before subscription to product 246. In this example, product 246 can be a complete or functional piece of software that is developed to perform tasks for user 206. In this example, trial environment 228 can also be implemented using third-party services from providers such as Databricks® and Snowflake®.

As depicted, trial manager 220 allocates computational resources 224 to trial environment 228. In this example, computational resources 224 are technical components and capabilities that computer system 204 uses to perform tasks and process data. Computational resources 224 are essential for running applications, executing commands, and carrying out operations. For example, computational resources 224 can include processors such as CPU and GPU, memory such as random-access memory (RAM), storage devices, network bandwidth, or any suitable computational resources. In this example, it should be understood that computational resources 224 may be shared by multiple users or multiple trial environments at the same time.

In this illustrative example, trial manager 220 monitors trial environment 228 to identify user activities 240 for user 206. In this illustrative example, user activities 240 are actions, behaviors, and interactions that user 206 performs while exploring or using applications and software in trial environment 228. For example, user activities 240 can include information associated with commands executed in trial environment 228 and frequency of user logins to trial environment 228 for user 206.

In this example, trial manager 220 determines engagement score 226 using user activities 240. Engagement score 226 is a measurement of how actively and meaningfully user 206 interacts with trial environments over a period of time.

In this illustrative example, engagement score 226 can also be calculated using other metrics. For example, trial manager 220 can use metrics such as usage intensity (UI), temporal patterns (TP), resource efficiency (RE), and contextual benchmarking (CB) for calculating engagement score 226.

Usage intensity (UI) is a measure of command frequency, complexity, and feature exploration depth. In this example, usage intensity (UI) incorporates feature coverage ratio across product capability spectrum, command sophistication levels based on hierarchical taxonomy, and user intent classification differentiating exploration from implementation activities.

In addition, temporal patterns (TP) are determined using analysis of session timing, duration, and consistency determined based on decay-weighted time-series analysis with logarithmic temporal decay, engagement velocity tracking to detect acceleration/declaration of interest, and session distribution patterns compared against conversion-correlated benchmarks.

Further, resource efficiency (RE) is the ratio of productive output to computational resources consumed by measuring successful operation completion rates versus resource utilization, tracking error rates and recovery patterns during product usage, and analyzing session quality through workflow completion metrics.

In this illustrative example, contextual benchmarking (CB) is a metric that compares patterns against known conversion indicators using industry-specific engagement models with dynamic baseline calibration, factors associated with product complexity adjustment, and peer group normalization for identifying significant deviations.

In this illustrative example, engagement score 226 can be calculated using the equation as shown below:

ES=(w₁×UI×c₁)+(w₂×TP×c₂)+(w₃ [symbol] ×c₃)+(w₄×CB×c₄) (1)

where w₁, w₂, w₃, and w₄ are weights dynamically adjusted using machine learning models 242 against historical conversion data, and c₁, c₂, c₃, and c₄ are confidence modifiers derived from statistical validation of predictive accuracy for usage intensity (UI), temporal patterns (TP), resource efficiency (RE), and contextual benchmarking (CB) in equation (1).

In this illustrative example, w₁, w₂, w₃, and w₄ in equation (1) can be continuously refined through a feedback loop integrating actual conversion outcomes. In this example, trial manager 220 can detect anomalous patterns using statistical outlier analysis and normalize anomalous patterns using confidence interval adjustments. In addition, trial manager 220 can use cross-feature exploration mapping to identify comprehensive usage versus targeted exploration. Further, trial manager 220 can apply predictive conversion indicators to regression analysis to identify patterns most predictive for subscription conversion.

In this example, a number of thresholds can be used to evaluate engagement score 226. In this illustrative example, predetermined policies and amount of computational resources from computational resources 224 can be configured for user 206 to use trial environment 228 based on evaluation of engagement score 226 using thresholds.

For example, trial manager 220 can determine if engagement score 226 for user 206 is within pre-defined range 236, which indicates that user activities 240 for user 206 are at a normal level. In this example, trial manager 220 continues to allocate the same amount of computational resources from computational resources 224 to trial environment 228 for user 206.

In addition, upon determining that engagement score 226 is not within the range for pre-defined range 236, trial manager 220 can determine if engagement score 226 for user 206 exceeds pre-defined threshold 212. In this example, user activities 240 for user 206 is at a high level if engagement score 226 exceeds pre-defined threshold 212. High levels of user activities can lead to insufficient allocation of computational resources. As a result, trial manager 220 can adjust amount of computational resources from computational resources 224 to trial environment 228 for user 206 such that trial environment 228 is allocated with more computational resources to perform tasks for user 206.

In an alternative illustrative example, trial manager 220 can further analyze logs 248 that is associated with user activities 240 to validate user activities 240 for user 206 before adjustment of computational resources 224. In this illustrative example, validation of user activities 240 ensures that user 206 is not engaged in malicious activity or abusing computational resources allocated to trial environment 228 for personal needs.

In this illustrative example, trial manager 220 can also recommend a subscription to product 246 to user 206 in response to determining that engagement score 226 exceeds pre-defined threshold 212.

On the other hand, upon determining that engagement score 226 is not within the range for pre-defined range 236 and does not exceed pre-defined threshold 212, trial manager 220 can determine if engagement score 226 for user 206 is less than second pre-defined threshold 218. In this example, user activities 240 for user 206 is at a low level if engagement score 226 is less than second pre-defined threshold 218.

Low levels of user activities can lead to excessive allocation of computational resources. As a result, trial manager 220 can adjust amount of computational resources from computational resources 224 to trial environment 228 for user 206 such that trial environment 228 is allocated with less computational resources that is sufficient to perform tasks for user 206.

In this illustrative example, trial manager 220 can allocate a portion of computational resources 224 that is freed from trial environment 228 to other trial environments and users with a high level of user activities. As a result, computational resources 224 can be dynamically managed in real-time to ensure smooth operations for all trial environments.

In this example, trial manager 220 can further categorize user 206 into group 252 from groups 230. Groups 230 are classifications for users based on patterns of behavior that may suggest harmful or suspicious intent. In this illustrative example, groups 230 can be used to determine if user 206 is engaged in malicious activities that pose cyber threats to computer system 204.

In this illustrative example, trial manager 220 can classify user 206 into group 252 based on user activities 240, services offered by product 246, and commands executed for product 246 simulated in trial environment 228. Subsequently, trial manager 220 determines whether anomalies 238 are associated with group 252. In this example, anomalies 238 are unusual or unexpected behaviors, events, or patterns that deviate from normal system operations and may indicate malicious activity. For example, anomalies 238 can include unusual login attempts, hidden malware process, misuse of system resources, or abnormal usage of system resources.

In this illustrative example, trial manager 220 can modify access for user 206 to trial environment 228 upon determining that group 252 is associated with anomalies 238. For example, trial manager 220 can terminate or limit access for user 206 to trial environment 228.

As depicted, computer system 204 includes machine intelligence 222. Machine intelligence 222 can include a set of machine learning models 242 and machine learning algorithms 244. Machine learning models 242 is a branch of artificial intelligence (AI) that enables computers to detect patterns and improve performance without direct programming commands. Rather than relying on direct input commands to complete a task, the set of machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. The set of machine learning models 242 and machine learning algorithms 244 may make computer system 204 a special purpose computer for adjusting computational resources 224 for trial environments such as trial environment 228. In addition, the set of machine learning models 242 can also be used for detecting anomalies 238 for computer system 204.

As depicted, the set of machine learning models 242 involves using machine learning algorithms 244 to build computation models based on samples of data. The samples of data used for training are referred to as training data or training datasets. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications.

In this illustrative example, the set of machine learning models 242 can be trained using user activities such as user activities 240, logs 248, data associated with groups 230 and anomalies 238. As a result, the set of machine learning models 242 is capable of performing tasks such as user classifications, anomaly detection, and automatic resource allocations as depicted above.

In this illustrative example, machine learning algorithms 244 can include supervised machine learning algorithms, semi-supervised machine learning algorithms, reinforcement learning algorithms, and unsupervised machine learning algorithms. In this illustrative example, above mentioned machine learning algorithms can train machine learning models using data containing both the inputs and desired outputs. Examples of machine learning algorithms include algorithms for neural networks, XGBoost, K-means clustering, and random forest.

In this illustrative example, trial manager 220 can use the set of machine learning models 242 to predict computational resources usage for trial environment 228 and dynamically adjust allocation of computational resources 224 to trial environment 228 based on predictions.

In this illustrative example, users such as user 206 can interact with computer system 204 through user inputs to computer system 204. For example, computer system 204 can receive user input 208 that includes values for defining pre-defined threshold 212, second pre-defined threshold 218, and pre-defined range 236. In addition, computer system 204 can receive user input 208 that includes commands that are associated with operation of trial environment 228 for user 206.

In this illustrative example, user input 208 can be generated by user 206 using human machine interface (HMI) 210. As depicted, human machine interface 210 includes display system 232 and input system 234. Display system 232 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 250 through user input 208 generated by input system 234. Input system 234 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. In this example, user 206 can provide user input 208 through graphical user interface 250.

In this example, trial environment 228 can offer a number of additional features for user 206. For example, trial environment 228 can provide unique security domains that goes beyond simple user isolation by implementing automatic credential rotation and real-time security policy enforcement. In this illustrative example, trial manager 220 continuously monitors potential security boundary violations and automatically adjusts security parameters without human intervention. As a result, trial manager 220 can effectively prevent data leakage between trial environments.

In an alternative illustrative example, trial environment 228 can also provide a reclamation mechanism. In this example, trial manager 220 actively monitors resource utilization patterns and automatically reclaims underutilized resources for trial environment 228. This feature can be coupled with a sophisticated conflict prevention algorithm that ensures resource reallocation does not impact active trials while maintaining optimal resource distribution across different trial environments.

In one illustrative example, one or more solutions are present that overcome a problem with dynamically adjusting computational resources for trial environments in real time. As a result, one or more technical solutions may provide an ability to increase efficiency and computational resource utilization for trial environments such as trial environment 228 in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which trial manager 220 in computer system 204 enables adjustment of computational resources allocations for trial environments based on demand. In particular, trial manager 220 transforms computer system 204 into a special purpose computer system as compared to currently available general computer systems that do not have trial manager 220.

For example, the dynamic control of computational resources helps to maintain smooth performance for computer system 204 during periods of varying user activity. In this example, adjusting computational resources in real time prevents slowdowns or crashes when usage increases because trial users often explore features in unpredictable ways. In a similar fashion, computer system 204 can scale down when demand drops to reduce unnecessary overhead.

In addition, dynamic adjustment of computational resources can lead to more efficient and cost-effective use of infrastructure. Instead of dedicating fixed computational resources to a trial environment that might be underused or overwhelmed, hardware systems can shift capacity based on demands. This reduces waste, prolongs hardware lifespan, and helps balance the load across physical or virtual machines. In addition, dynamic adjustment of computational resources also enables better energy consumption and supports modern practices such as virtualization and cloud computing, where resources are shared and allocated based on demand.

In the illustrative example, the use of trial manager 220 in computer system 204 integrates processes into a practical application for computational resource adjustment in trial environments. Trial manager 220 improves efficiency of computational resource utilization such that performance of computer system 204 can be increased. In other words, trial manager 220 in computer system 204 is directed to a practical application of processes integrated into trial manager 220 in computer system 204 that enables utilization of computational resources in an efficient manner.

The illustration of trial management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, processor set 216 can be part of computational resources 224 that works to perform tasks and operations in trial environments such as trial environment 228.

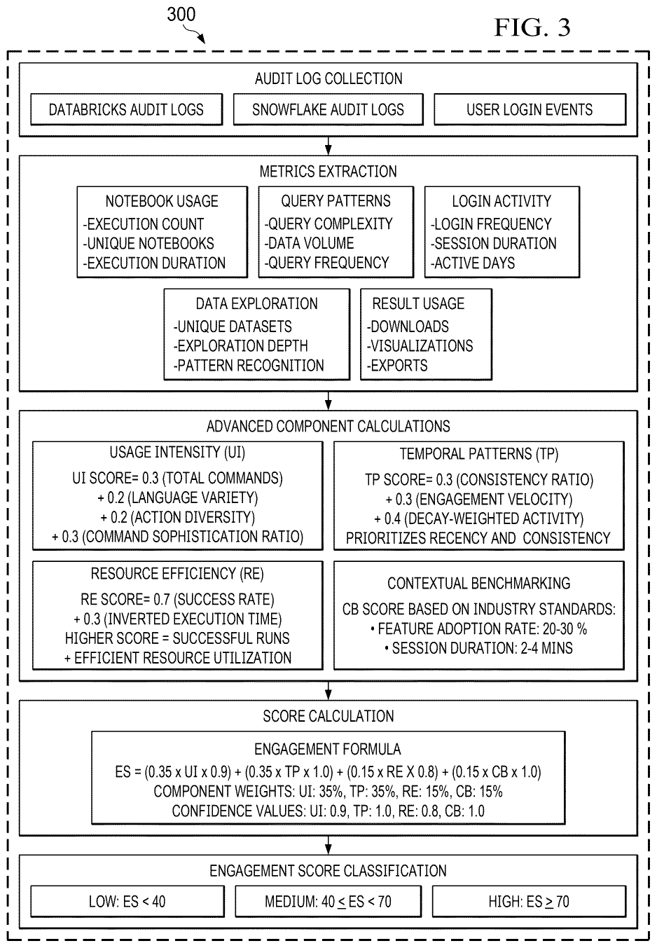

FIG. 3 depicts a process flow for generating engagement scores for users in accordance with an illustrative embodiment. In this illustrative example, execution of process flow 300 can be implemented using trial manager 220 and computer system 204 in FIG. 2.

In this illustrative example, process flow 300 is associated with trial environments that are implemented using third-party services from Databricks® and Snowflake®. In this illustrative example, process flow 300 starts with collecting logs for the users that use the trial environments implemented using third-party services from Databricks® and Snowflake®. For example, Databricks® Audit logs, Snowflake® Audit logs, and user login events can be collected as audit logs for further analysis.

In this illustrative example, a number of features are extracted from the audit logs for determining metrics for the users that use the trial environments. For example, metrics such as query patterns can be determined using information associated with query complexity, data volume, and query frequency. Further, metrics of login activity can be determined using information that includes login frequency, session duration, and active days. In addition, metrics of notebook usage can be determined using information that includes execution count, unique notebooks, and execution durations for the users.

In this illustrative example, notebooks in the trial environment refer to an interactive, web-based interface that allows users to write, execute, and test code in a controlled, temporary setup. In other words, a notebook serves as a hands-on workspace that enables users to experiment with capabilities of the trial environment without the need to install anything locally.

As depicted in FIG. 3, the metrics determined based on collected features are used for determining engagement scores for the users. In this example, the determined engagement scores for the users can be examples of engagement score 226 in FIG. 2.

In this illustrative example, the engagement scores can be calculated in a number of different ways. For example, the engagement scores can be calculated using “notebook usage score”, “activity score”, and “interaction score”, as illustrated in FIG. 3. In this illustrative example, each score mentioned above is a quantitative measurement that represents a magnitude of interactions between the users and the trial environments.

As depicted, engagement scores can also be determined by considering advanced components such as usage intensity (UI), temporal patterns (TP), resource efficiency (RE), and contextual benchmarking (CB). In this illustrative example, each advanced component in FIG. 3 is calculated differently. For example, usage intensity (UI) is calculated based on total commands, languages variety, action diversity, and command sophistication ratio while temporal patterns (TP) are calculated based on consistency ratio, engagement velocity, and decay-weighted activity.

As depicted in FIG. 3, engagement score can be calculated using the equation as shown below:

ES=(w₁×UI×c₁)+(w₂×TP×c₂)+(w₃ [symbol] ×c₃)+(w₄×CB×c₄)

where w₁, w₂, w₃, and w₄ are weights dynamically adjusted using machine learning models against historical conversion data, and c₁, c₂, c₃, and c₄ are confidence modifiers derived from statistical validation of predictive accuracy for usage intensity (UI), temporal patterns (TP), resource efficiency (RE), and contextual benchmarking (CB) in equation.

In this illustrative example, w₁, w₂, w₃, and w₄ in equation of calculating the engagement score are 0.35, 0.35, 0.15, and 0,15, respectively. In addition, c₁, c₂, c₃, and c₄ are 0.9, 1.0, 0.8, and 1.0, respectively.

In this illustrative example, the engagement scores can be classified into “low engagement”, “medium engagement”, or “high engagement” based on values of the engagement scores. For example, an engagement score of “10” would be classified as “low engagement”, an engagement score of “50” would be classified as “medium engagement”, and an engagement score of “80” would be classified as “high engagement”. In this illustrative example, a list of actions can be performed to the users and the trial environments based on the classification of the engagement scores. For example, allocation of computational resources and access modifications can be performed based on the classification of the engagement scores.

In this example, the range of “40” to “70” can be an example of pre-defined range 236 in FIG. 2, the value of “40” can be an example of second pre-defined threshold 218 in FIG. 2, and the value of “70” can be an example of pre-defined threshold 212 in FIG. 2.

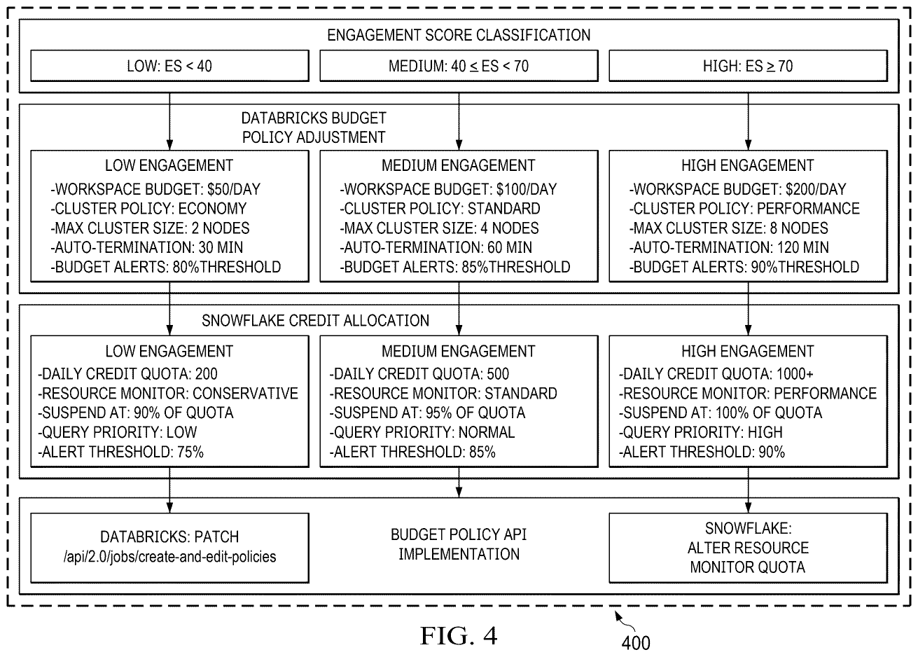

FIG. 4 depicts adjustment of budget policies and computational resources in accordance with an illustrative embodiment. In this illustrative example, adjustments illustrated in process flow 400 can be implemented using trial manager 220 and computer system 204 in FIG. 2.

As depicted, process flow 400 explicitly defines amounts of budgets and computational resources allocated to each user based on the engagement scores. For example, users with low engagement scores are allocated with a workspace budget of $50/day and a maximum of two nodes from cluster while users with high engagement scores are allocated with a workspace budget of $200/day and maximum of eight nodes from cluster from services provided by Databricks®.

In another example, users with low engagement scores are allocated with a daily credit quota of 200 and low query priority while users with high engagement scores are allocated with a daily credit quota of more than 1,000 and high query priority from services provided by Snowflake®.

In this illustrative example, it should be understood that amount of budgets and computational resources allocated to each user dynamically changes when the engagement scores for the users change over time. For example, the workspace budget and daily credit quota can be adjusted from $50/day and 200/day to $200/day and more than 1,000/day if a user with a low engagement score increases interactions with the trial environments and becomes a user with high engagement score.

The illustration of process flow 400 in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, amounts of budgets and computational resources from other internal services or third-party services can be dynamically allocated to each user based on the engagement scores for the users.

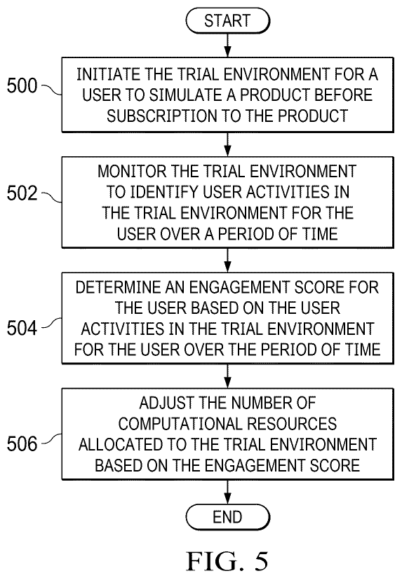

With reference now to FIG. 5, a flowchart illustrating a process for adjusting computational resources to a trial environment is shown in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in computational resources manager 220 in computer system 204 in FIG. 2.

The process begins by initiating the trial environment for a user to simulate a product before subscription to the product (step 500). In step 500, a number of computational resources are allocated to the trial environment. The process monitors the trial environment to identify user activities in the trial environment for the user over a period of time (step 502).

The process determines an engagement score for the user based on the user activities in the trial environment for the user over the period of time (step 504). The process adjusts the number of computational resources allocated to the trial environment based on the engagement score (step 506). The process terminates thereafter.

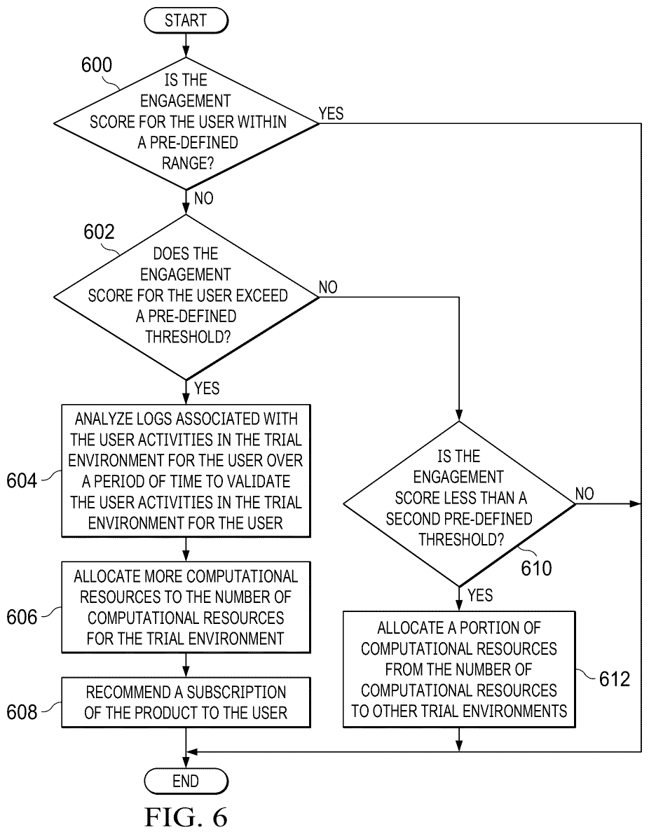

With reference now to FIG. 6, a flowchart illustrating a process for allocating computational resources to a trial environment is shown in accordance with an illustrative embodiment. The process in this flowchart is an example of an implementation for step 506 in FIG. 5.

The process begins by determining whether the engagement score for the user is within a pre-defined range (step 600). If the engagement score for the user is within the pre-defined range, the process terminates thereafter.

With reference again to step 600, if the engagement score for the user is not within the pre-defined range, the process determines whether the engagement score exceeds a pre-defined threshold (step 602). If the engagement score does not exceed the pre-defined threshold, the process determines whether the engagement score is less than a second pre-defined threshold (step 610).

If the engagement score is not less than the second pre-defined threshold, the process terminates thereafter. With reference again to step 610, if the engagement score is less than the second pre-defined threshold, the process allocates a portion of computational resources from the number of computational resources to other trial environments (step 612). The process terminates thereafter.

With reference again to step 602, if the engagement score exceeds a pre-defined threshold, the process analyzes logs associated with the user activities in the trial environment for the user over a period of time to validate the user activities in the trial environment for the user (step 604). The process allocates more computational resources to the number of computational resources for the trial environment (step 606). The process recommends a subscription of the product to the user (step 608). The process terminates thereafter.

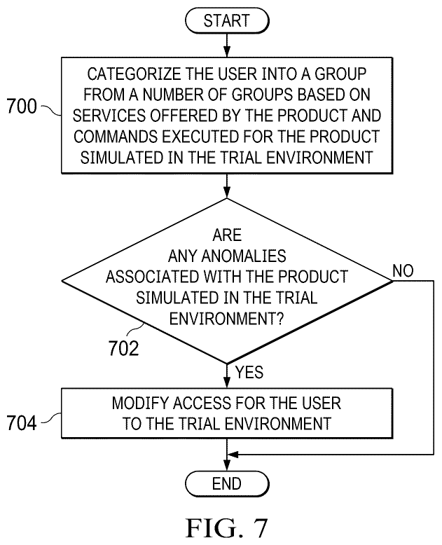

With reference now to FIG. 7, a flowchart illustrating a process for modifying access to the trial environment for the user is shown in accordance with an illustrative embodiment. The process in this figure is an example of an additional step that can be performed with the steps in FIG. 6.

The process begins by categorizing the user into a group from a number of groups based on services offered by the product and commands executed for the product simulated in the trial environment (step 700). The process determines whether any anomalies are associated with the product simulated in the trial environment (step 702). If no anomalies are associated with the product simulated in the trial environment, the process terminates thereafter.

With reference again to step 702, if there are anomalies associated with the product simulated in the trial environment, the process modifies access for the user to the trial environment (step 704). The process terminates thereafter.

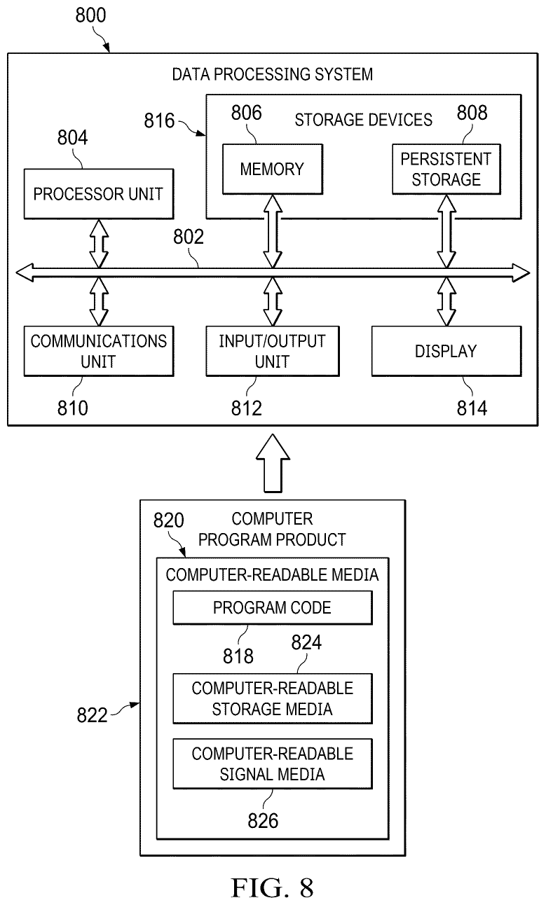

With reference now to FIG. 8, an illustration of a block diagram of a data processing system is depicted in accordance with an illustrative embodiment. Data processing system 800 may be used to implement server computer 104 and server computer 106 and client devices 110 in FIG. 1, as well as computer system 204 in FIG. 2. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (GPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808. Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In one example, computer-readable media 820 may be computer-readable storage media 824 or computer-readable signal media 826.

In these illustrative examples, computer-readable storage media 824 is a physical or tangible storage device used to store program code 818 rather than a medium that propagates or transmits program code 818. Computer-readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 818 may be transferred to data processing system 800 using computer-readable signal media 826. Computer-readable signal media 826 may be, for example, a propagated data signal containing program code 818. For example, computer-readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for managing a trial environment, the computer-implemented method comprising:
initiating, by a processor set, the trial environment for a user to simulate a product before subscription to the product, wherein a number of computational resources are allocated to the trial environment;
monitoring, by the processor set, the trial environment to identify user activities in the trial environment for the user over a period of time;
determining, by the processor set, an engagement score for the user based on the user activities in the trial environment for the user over the period of time; and
adjusting, by the processor set, the number of computational resources allocated to the trial environment based on the engagement score.

2. The computer-implemented method of claim 1, wherein adjusting, by the processor set, the number of computational resources allocated to the trial environment based on the engagement score comprises:
determining, by the processor set, whether the engagement score for the user is within a pre-defined range;
in response to determining that the engagement score for the user is not within the pre-defined range, determining, by the processor set, whether the engagement score exceeds a pre-defined threshold;
in response to determining that the engagement score exceeds the pre-defined threshold, analyzing, by the processor set, logs associated with the user activities in the trial environment for the user over a period of time to validate the user activities in the trial environment for the user; and
allocating, by the processor set, more computational resources to the number of computational resources for the trial environment.

3. The computer-implemented method of claim 2, further comprising:
recommending, by the processor set, a subscription of the product to the user.

4. The computer-implemented method of claim 2, further comprising:
categorizing, by the processor set, the user into a group from a number of groups based on services offered by the product and commands executed for the product simulated in the trial environment;
identifying, by the processor set, whether any anomalies are associated with the product simulated in the trial environment; and
in response to determining that anomalies are associated with the product simulated in the trial environment, modifying, by the processor set, access of the user to the trial environment.

5. The computer-implemented method of claim 4, wherein the access of the user to the trial environment is modified by terminating the access of the user to the trial environment.

6. The computer-implemented method of claim 2, further comprising:
in response to determining that the engagement score for the user does not exceed the pre-defined threshold, determining, by the processor set, whether the engagement score is less than a second pre-defined threshold; and
in response to determining that the engagement score is less than a second pre-defined threshold, allocating, by the processor set, a portion of computational resources from the number of computational resources to other trial environments.

7. The computer-implemented method of claim 1, wherein the user activities comprise information associated with commands executed in the trial environment and frequency of user logins to the trial environment.

8. A computer system for managing a trial environment, comprising:
a processor set;
a set of one or more computer-readable storage media; and
program instructions stored on the set of one or more storage media to cause the processor set to perform operations comprising:
initiating the trial environment for a user to simulate a product before subscription to the product, wherein a number of computational resources are allocated to the trial environment;
monitoring the trial environment to identify user activities in the trial environment for the user over a period of time;
determining an engagement score for the user based on the user activities in the trial environment for the user over the period of time; and
adjusting the number of computational resources allocated to the trial environment based on the engagement score.

9. The computer system of claim 8, wherein adjusting the number of computational resources allocated to the trial environment based on the engagement score comprises:
determining whether the engagement score for the user is within a pre-defined range;
in response to determining that the engagement score for the user is not within the pre-defined range, determining whether the engagement score exceeds a pre-defined threshold;
in response to determining that the engagement score exceeds the pre-defined threshold, analyzing logs associated with the user activities in the trial environment for the user over a period of time to validate the user activities in the trial environment for the user; and
allocating more computational resources to the number of computational resources for the trial environment.

10. The computer system of claim 9, wherein the operations further comprising:
recommending, by the processor set, a subscription of the product to the user.

11. The computer system of claim 9, wherein the operations further comprising:
categorizing the user into a group from a number of groups based on services offered by the product and commands executed for the product simulated in the trial environment;
identifying whether any anomalies are associated with the product simulated in the trial environment; and
in response to determining that anomalies are associated with the product simulated in the trial environment, modifying access of the user to the trial environment.

12. The computer system of claim 11, wherein the access of the user to the trial environment is modified by terminating the access of the user to the trial environment.

13. The computer system of claim 9, wherein the operations further comprising:
in response to determining that the engagement score for the user does not exceed the pre-defined threshold, determining whether the engagement score is less than a second pre-defined threshold; and
in response to determining that the engagement score is less than a second pre-defined threshold, allocating a portion of computational resources from the number of computational resources to other trial environments.

14. The computer system of claim 8, wherein the user activities comprise information associated with commands executed in the trial environment and frequency of user logins to the trial environment.

15. A computer program product for managing a trial environment, comprising:
a set of one or more computer-readable storage media;
program instructions stored in the set of one or more computer-readable storage media to perform operations comprising:
initiating, by a processor set, the trial environment for a user to simulate a product before subscription to the product, wherein a number of computational resources are allocated to the trial environment;
monitoring, by the processor set, the trial environment to identify user activities in the trial environment for the user over a period of time;
determining, by the processor set, an engagement score for the user based on the user activities in the trial environment for the user over the period of time; and
adjusting, by the processor set, the number of computational resources allocated to the trial environment based on the engagement score.

16. The computer program product of claim 15, wherein adjusting, by the processor set, the number of computational resources allocated to the trial environment based on the engagement score comprises:
determining, by the processor set, whether the engagement score for the user is within a pre-defined range;
in response to determining that the engagement score for the user is not within the pre-defined range, determining, by the processor set, whether the engagement score exceeds a pre-defined threshold;
in response to determining that the engagement score exceeds the pre-defined threshold, analyzing, by the processor set, logs associated with the user activities in the trial environment for the user over a period of time to validate the user activities in the trial environment for the user; and
allocating, by the processor set, more computational resources to the number of computational resources for the trial environment.

17. The computer program product of claim 16, wherein the operations further comprising:
recommending, by the processor set, a subscription to the product to the user.

18. The computer program product of claim 16, wherein the operations further comprising:
categorizing, by the processor set, the user into a group from a number of groups based on services offered by the product and commands executed for the product simulated in the trial environment;
identifying, by the processor set, whether any anomalies are associated with the product simulated in the trial environment; and
in response to determining that anomalies are associated with the product simulated in the trial environment, modifying, by the processor set, access of the user to the trial environment.

19. The computer program product of claim 18, wherein the access of the user to the trial environment is modified by terminating the access of the user to the trial environment.

20. The computer program product of claim 16, wherein the operations further comprising:
in response to determining that the engagement score for the user does not exceed the pre-defined threshold, determining, by the processor set, whether the engagement score is less than a second pre-defined threshold; and
in response to determining that the engagement score is less than a second pre-defined threshold, allocating, by the processor set, a portion of computational resources from the number of computational resources to other trial environments.
